(19) United States
(12) Patent Application Publication
(10) Pub. No.: US 2013/0106909 A1
(43) Pub. Date: May 2, 2013

(54) DRAWING APPARATUS

(71) Applicant: FUJITSU LIMITED, Kawasaki-shi (JP)

(72) Inventor: Sumiko TORIMARU, Kawasaki (JP)

(73) Assignee: FUJITSU LIMITED, Kawasaki-shi (JP)

(21) Appl. No.: 13/721,288

(22) Filed: Dec. 20, 2012

Related U.S. Application Data
(63) Continuation of application No. PCT/JP2010/061168, filed on Jun. 30, 2010.

(51) Int. Cl. G06T 11/00

(52) U.S. Cl. CPC G06T 11/00
USPC 345/629

(57) ABSTRACT

A drawing apparatus includes a figure information generating unit sequentially generating figure information representing each figure based on a drawing operation using a line with border to which color information of a border and an inner part is given; a drawing information generating unit generating drawing information using the figure information; and a drawing processing unit executing a drawing process based on the drawing information, wherein when a figure forming a pre-update image and a new figure overlap each other and when colors of borders and inner parts of the overlapping figures are the same, then the drawing information generating unit updates the pre-update drawing information with new drawing information which represents a figure in which the inner parts of the overlapping parts are united.

### CROSS-REFERENCE TO RELATED APPLICATION

This application is a continuation application of International Application PCT/JP2010/061168 filed on Jun. 30, 2010, the entire contents of which are incorporated herein by reference.

### FIELD

The embodiments described herein relates to a drawing apparatus for drawing figures using lines with border, and a drawing program for causing a processing unit to operate as a drawing apparatus.

### BACKGROUND

When drawing figures using a computer and the like, various options may be available for drawing the figures with lines of a wide variety of colors and lines with border and so forth.

As for drawing characters and patterns and the like using lines with border, since the stroke orders are taken into account, problems occur that unnecessary borders are formed at the parts where the lines overlap each other and the lines cannot be drawn as united characters and patterns and the like. When the overlapping lines are forced to unite each other, the stroke orders are left out and intended figures are not drawn.

Drawing methods are developed to prevent borders of figures from being deleted. However, since the above problems are caused because unnecessary borders are drawn, these methods cannot resolve the problems.

### Patent Document 1

Japanese Laid-Open Patent Publication No.H07-210707

### SUMMARY

A drawing apparatus disclosed herein includes a figure information generating unit, a drawing information generating unit and a drawing processing unit.

The figure information generating unit sequentially generates figure information representing each figure, in which one stroke of line with border is recognized as one figure, based on a drawing operation using a line with border to which color information of the border and the inner part is given.

And the drawing information generating unit generates drawing information on which drawing is based using the figure information described above.

Further, the drawing processing unit executes drawing processes based on the drawing information generated by the drawing information generating unit.

Here, the drawing information generating unit executes the process indicated by (3) described below when both conditions (1) and (2) described below are satisfied.

### Concretely,

(1) A figure forming a pre-update image represented by pre-update drawing information and a new figure represented by new drawing information overlap each other.

(2) In addition, the colors of the borders of the overlapping figures are the same and the colors of the inner parts of the overlapping figures are the same.

(3) When both conditions (1) and (2) as described above are satisfied, the drawing information generating unit updates the pre-update drawing information with new drawing information which represents a figure in which the inner parts of the overlapping parts are united.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1A is a comparative example, and FIG. 1B illustrates a figure drawn using lines with border using a drawing apparatus according to an embodiment.

FIGS. 2A(A), 2A(B) and 2A(C) are first comparative examples, FIGS. 2B(A), 2B(B) and 2B(C) are second comparative examples, and FIGS. 2C(A), 2C(B) and 2C(C) are diagrams illustrating examples for a drawing apparatus according to an embodiment.

FIG. 3 is a functional block diagram illustrating a drawing apparatus according to a first embodiment.

FIG. 4 is an external diagram illustrating a note PC (Personal Computer) included in a drawing apparatus according to a second embodiment.

FIG. 5 is an internal block diagram of the note PC depicted in FIG. 4.

FIG. 6 is a diagram illustrating an example of a handwritten figure drawn by mouse operations.

FIG. 7 is a diagram illustrating the movement of a pen drawing the figure depicted in FIG. 6.

FIG. 8 is a diagram illustrating an example of figure information.

FIG. 9 is a diagram illustrating information in a phase of generating drawing information based on the figure information depicted in FIG. 8.

FIG. 10 is a diagram illustrating pixels used for drawing the figure depicted in FIGS. 6 and 7.

FIG. 11 is a diagram illustrating as example of the calculations of pixels used for drawing the inner parts of a figure at each point of the movement of the pen.

FIG.12 is a diagram illustrating pixels used for drawing the inner parts of the figure depicted in FIGS. 6 and 7.

FIG. 13 is a diagram illustrating pixels used for drawing the borders of the figure depicted in FIGS. 6 and 7.

FIGS. 14A and 14B are diagrams illustrating the drawing information when the figures depicted in FIGS. 6 and 7 exist solely.

FIG. 15 is a flowchart illustrating processes for sequentially updating drawing information based on a plurality of figure information.

FIG. 16 is a diagram illustrating as an image the drawing information before updating.

FIG. 17 is a diagram illustrating an image in which a new figure is added to the figure depicted in FIG. 16 by new drawing operations.

FIG. 18 is a diagram illustrating each part in four overlapping patterns.

FIGS. 19A, 19B, 19C and 19D are diagrams illustrating the drawing information in the four overlapping patterns.

FIG. 20 is a diagram illustrating as an image the drawing information which is newly generated by the update processes.

FIGS. 21A and 21B are flowcharts of drawing information regeneration processes which are executed when a modification request is submitted.

FIG. 22 illustrates an image displayed on a display before the modification processes.

FIG. 23 illustrates an image displayed on a display after the modification processes.

FIG. 24 illustrates an image in which the borders corresponding to the boundaries between FIG. 1 and FIG. 3 are deleted.

FIG. 25 illustrates an image of a first stage of the update processes of drawing information.

FIG. 26 illustrates an image of a second stage of the update processes of drawing information.

FIG. 27 illustrates an image of a third stage of the update processes of drawing information.

FIG. 28 illustrates an image of a fourth stage of the update processes of drawing information.

### DESCRIPTION OF EMBODIMENTS

Specific embodiments will be described hereinafter with reference to comparative examples.

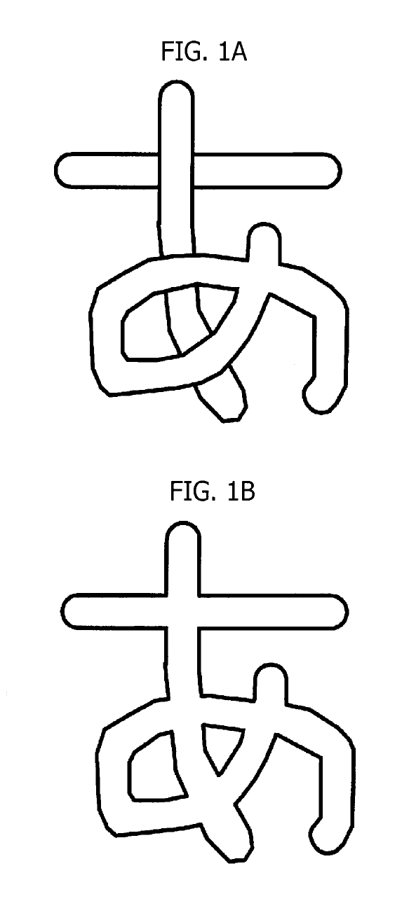

FIG. 1A is a comparative example, and FIG. 1B illustrates a figure drawn using lines with border using a drawing apparatus according to an embodiment.

In the comparative example illustrated in FIG. 1A, the overlapping parts of the lines are not united.

In FIG. 1B, a figure is formed by deleting the borders of the overlapping parts of the lines and uniting the overlapping parts.

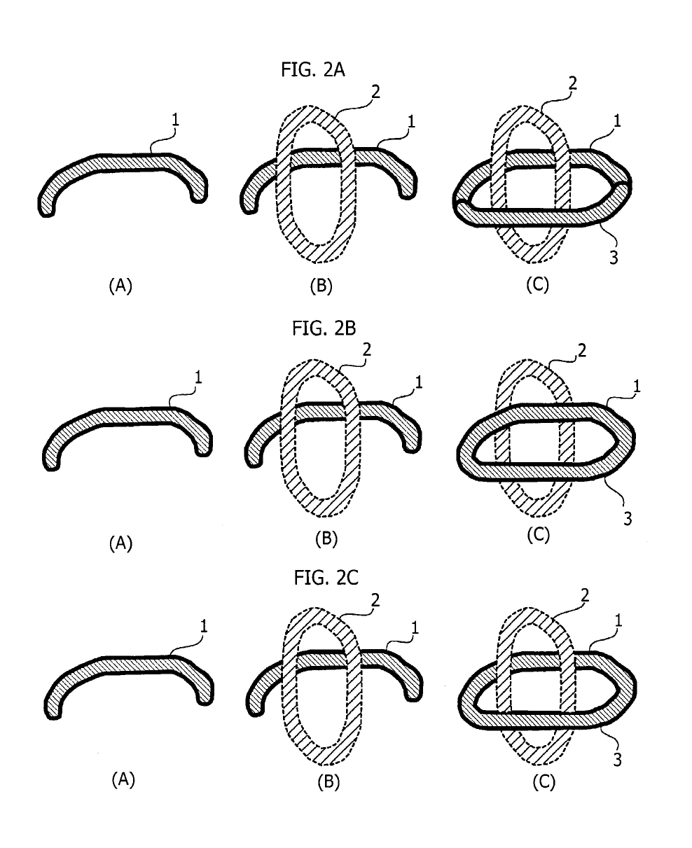

FIGS. 2A(A), 2A(B) and 2A(C) are first comparative examples, FIGS. 2B(A), 2B(B) and 2B(C) are second comparative examples, and FIGS. 2C(A), 2C(B) and 2C(C) are diagrams illustrating examples when using a drawing apparatus according to an embodiment.

FIGS. 2A(A), 2A(B) and 2A(C) are diagrams illustrating a character drawn according to its stroke order without uniting processes. First, a figure corresponding to one stroke, FIG. 1, is drawn as illustrated in FIG. 2A(A). Next, a figure corresponding to the following stroke, FIG. 2, is drawn as illustrated in FIG. 2A(B). Here, FIG. 2 is depicted with a color different from that of FIG. 1.

In this disclosure, when two figures (for example, FIG. 1 and FIG. 2) are compared to show that at least one of the colors of the borders and the inner parts of the figures is different, each figure is referred to as “a figure with a different color”.

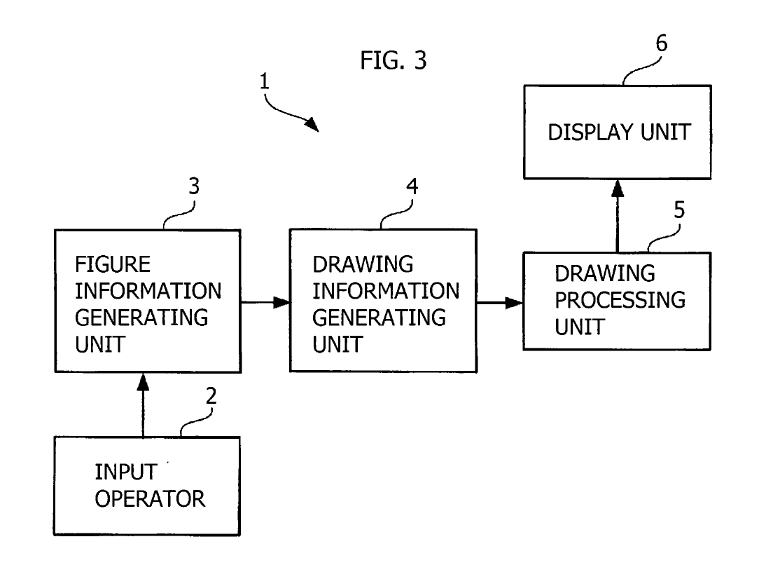

Next, FIG. 2A(C) illustrates FIG. 3 drawn with the same color with FIG. 1. In FIG. 2A(C), uniting processes are not executed so that borders remain drawn at the joint parts of FIGS. 1 and 3.

As for FIGS. 2B(A), 2B(B) and 2B(C), FIGS. 2B(A) and 2B(B) are the same as FIGS. 2A(A) and 2A(B) respectively. In FIG. 2B(C), FIGS. 1 and 3 are redrawn as a united figure. However, in this case, not only FIG. 3 but FIG. 1 is drawn to come to the front of FIG. 2, and therefore the outcome is not a figure as intended.

FIGS. 2C(A), 2C(B) and 2C(C) are diagrams illustrating an example when using a drawing apparatus according to the embodiment as described above. FIG. 2C(A) is the same as FIGS. 2A(A) and 2B(A), and FIG. 2C(B) is the same as FIG. 2A(B) and 2B(B). In FIG. 2C(C), FIG. 1 runs behind FIG. 2 and is united with FIG. 3.

In each embodiment described below, the drawings illustrated in FIGS. 2B(A), 2B(B), 2B(C), 2C(A), 2C(B) and 2C(C) are accomplished.

FIG. 3 is a functional block diagram illustrating a drawing apparatus according to a first embodiment.

A drawing apparatus illustrated in FIG. 3 includes an input operator 2, a figure information generating unit 3, a drawing information generating unit 4, a drawing processing unit 5, and a display 6.

The input operator 2 is an input operator for accepting drawing operations by users. For example, the input operator 2 maybe a pen-type input operator, and instead a mouse, which is a kind of pointing device, may be used as input operator.

And the figure information generating unit 3 sequentially generates, based on drawing operations of the input operator 2 using lines with border where each color information is given to the borders and the inner parts, figure information of each figure representing one stroke of line with border.

And the drawing information generating unit 4 generates, based on the figure information generated by the figure information generating unit 3, drawing information which forms the basis of drawing processes.

And the drawing processing unit 5 executes drawing processes based on the drawing information generated by the drawing information generating unit 4.

Further, the display 6 displays images based on the image data generated by the drawing processes executed by the drawing processing unit 5.

Here, the drawing information generating unit 4 executes the process indicated by (6) described below when both conditions (4) and (5) described below are satisfied. Concretely,

(4) A figure which forms a pre-update image which is represented by pre-update drawing information and a new figure which is represented by new drawing information overlap each other.

(5) In addition, the colors of the borders of the overlapping figures are the same and the colors of the inner parts of the overlapping figures are the same.

(6) When both conditions (4) and (5) as described above are satisfied, the drawing information generating unit 4 updates the pre-update drawing information with the new drawing information which represents a figure in which the inner parts of the overlapping parts is united.

Specifically, the drawing information generating unit 4 divides the new figure represented by the new figure information into “non-overlapping areas” which do not overlap the pre-update image represented by the pre-update drawing information and “overlapping areas” which overlaps the pre-update image, and then executes the following processes.

(7) As for the “non-overlapping areas”, the drawing information generating unit adds the drawing information which is based on the new figure information to the pre-update drawing information.

As for the “overlapping areas”, in addition to the above process, the drawing information generating unit divides the areas into the “border-overlapping areas”, which overlaps the border of the figure forming the pre-update image, and the “inner-part-overlapping areas”, which overlaps the inner part of the figure forming the pre-update image.

(8) As for the “border-overlapping areas”, the unit updates the pre-update drawing information with the new drawing information which is based on the figure information representing the new figure.

(9) As for the “inner-part-overlapping areas”, the drawing information generating unit compares the new figure with the figure which forms the pre-update image and overlaps the new figure to compare the colors of the borders of these figures and the colors of the inner parts thereof respectively. And when either the colors of the borders or the colors of the inner parts are different, the drawing information generating unit updates the pre-update drawing information with the new drawing information which is based on the figure information representing the new figure.

The drawing information generating unit 4 executes the processes, which include the processes (7) to (9) as described above, for updating the pre-update drawing information with the post-update drawing information, in sequential order from the figure information generated by the preceding drawing operations to the figure information generated by the following drawing operations. The drawing information generating unit 4 executed the processes described above to generate the latest drawing information.

In addition, the figure information generating unit 3 executes the following processes when the unit receives a modification request of a figure which has already been drawn by drawing operations. That is:

(10) The figure information generating unit determines whether the conditions where a figure which forms the pre-update image represented by the pre-update drawing information and a figure which is subject to the modification request are overlapping each other, the colors of the borders of the overlapping figures are the same, and the colors of the inner parts thereof are the same are satisfied or not. And when the conditions are satisfied, the figure information generating unit modifies, according to the modification request, the figure information of the figure which is subject to the modification request, and similarly modifies, according to the modification request, the figure information of the figure overlapping the figure which is subject to the modification request.

Further, the drawing information generating unit 4 generates new drawing information when the figure information generating unit 3 modifies the figure information.

In the first embodiment illustrated in FIG. 3, a figure in which the unnecessary borders of the overlapping parts are deleted and the inner parts thereof are united is drawn on the display 6.

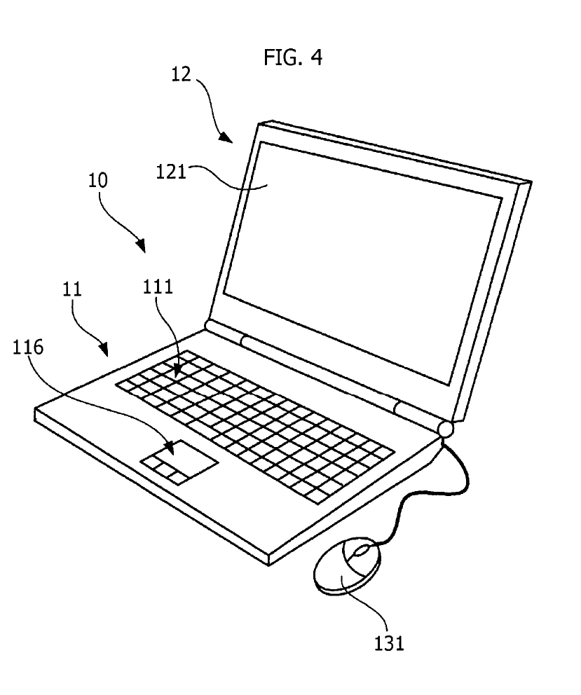

FIG. 4 is an external diagram illustrating a note-type personal computer (hereafter, referred to as “note PC”) included in a drawing apparatus according to a second embodiment. Here, the drawing apparatus includes the note PC 10 illustrated in FIG. 4 and a drawing program run in the note PC 10.

The note PC 10 illustrated in FIG. 4 includes a body unit 11 and a display unit 12.

The body unit 11 includes thereon a keyboard 111 and a trackpad 116, which is a kind of pointing device. And the body unit 11 includes therein a variety of electronic devices such as a CPU (central processing unit), a hard disk drive, a graphic unit. In addition, the display unit 12 is supported by the body unit 11 to freely open and close, and includes a display 121 in the center thereof.

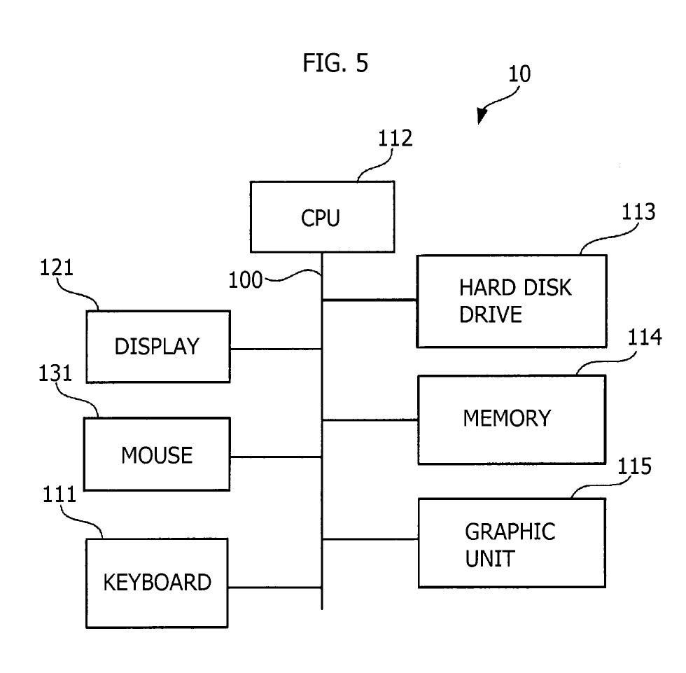

FIG. 5 is an internal block diagram of the note PC depicted in FIG. 4. FIG. 5 illustrates elements for explaining the present embodiment.

FIG. 5 illustrates the CPU 112, the hard disk drive 113, a memory 114, the graphic unit 115, the display 121, and the mouse 131, and these elements are connected to one another via bus 100.

Here, the CPU 112 is a central processing unit for running programs.

In addition, the hard disk drive 113 is a mass-storage device for storing a variety of programs and data and the like.

Further, the memory 114 is a memory for deploying programs to be run by the CPU 112 which are read out from the hard disk drive 113. The memory 114 also stores a variety of temporary data.

The graphic unit 115 is an electronic circuit for executing drawing processes of images displayed on the display 121.

The display 121 is an output device for display a variety of images.

The mouse 131 is a pointing device for moving a cursor on the display 121 and pointing an arbitrary point on the display 121.

Here, although the trackpad 116 has functions similar to the mouse 113, the explanation below assumes that the mouse 131 is used for drawing operations.

Moreover, the keyboard 111 is an input device for users' key inputs.

The hard disk derive 113 of the note PC 10 stores a drawing program, which is to be read out from the hard disk drive 113 and deployed in the memory 114. The drawing program deployed in the memory 114 is run by the CPU 112.

Users manipulate the mouse 131 to draw line figures on the display 121. According to the mouse manipulation, figure information as described later is constructed in the memory 114, and drawing information which is the basis of drawing on the display 121 is generated from the figure information. The drawing information is also deployed in the memory 114. The drawing information in the memory 114 is read in the graphic unit 115. The graphic unit 115 executes drawing processes for drawing on the display 121 based on the drawing information to generate image data. The image data generated by the drawing processes is sent to the display 121. Then the display 121 displays images based on the image data.

In this second embodiment, when mouse 131 is used to perform drawing operations, the focus is put on the drawing using lines with border.

A line with border is a two-color figure where the border of a line figure drawn by mouse operations is represented with a color which is different from that of the inner part of the line figure. Here, a figure corresponding to one stroke (corresponding to one mouse operation) is one figure, and plural figures form one whole diagram. The colors of the borders and the inner parts can be modified for each figure corresponding to one stroke. Here, when two figures are compared to show that both colors of the borders and the inner parts are the same, the two figures are referred to as “figures having the same colors”. In this embodiment, the thicknesses (widths) of the borders and the inner parts can be modified. However, even when the thicknesses (widths) differ from one figure to another, the figures with the same colors of the borders and the inner parts are referred to as figures having the same colors.

The thicknesses and colors of the borders and the inner parts of lines with border can be specified on the display by displaying a pull-down screen on the display 121 by mouse operations. Alternatively, the thicknesses and colors can be specified by key operations using the keyboard 111. These operations are so common that the detailed explanations are omitted here.

Examples of figure information and drawing information generated in the note PC in this embodiment are explained first hereinafter.

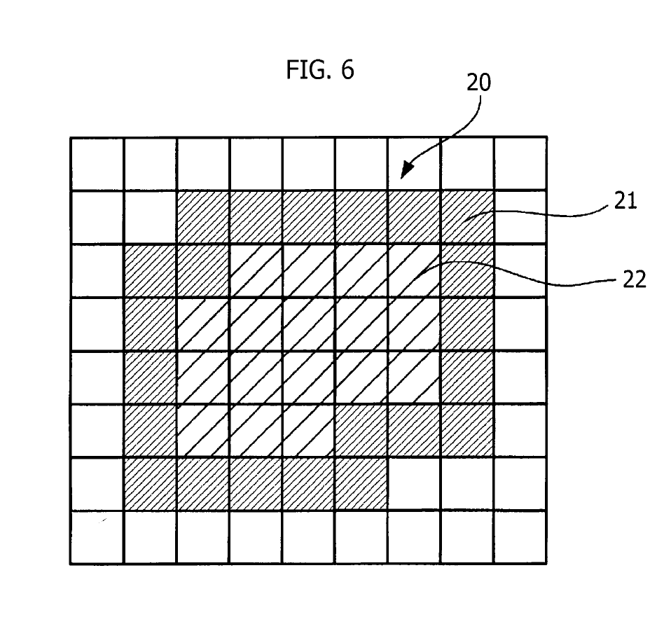

FIG. 6 is a diagram illustrating an example of a handwritten figure drawn by mouse operations.

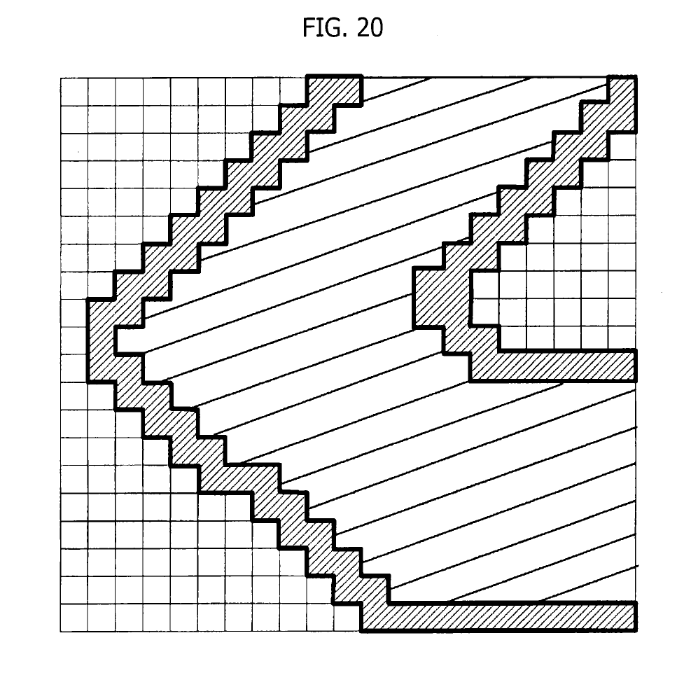

Cells depicted in FIG. 6 represent pixels. In addition, the FIG. 20 depicted in FIG. 6 includes a border 21 and an inner part 22. One color is assigned to the border 21 and another color is assigned to the inner part 22. As described above, the colors of the border 21 and the inner part 22 can be arbitrarily specified by a user.

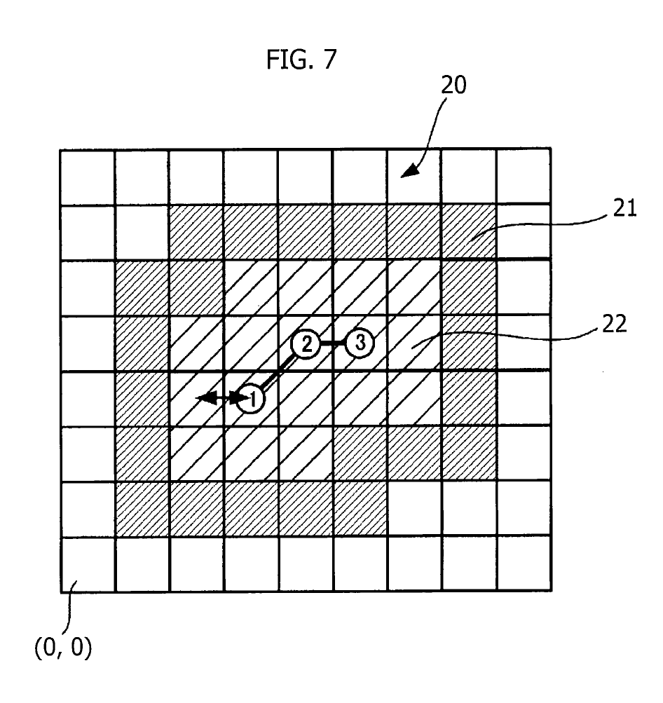

FIG. 7 is a diagram illustrating the movement of a pen drawing the FIG. 20 depicted in FIG. 6.

As described above, the mouse is used in place of the pen and the figure is drawn by the mouse operations, and a mouse, for convenience, may be referred to as “pen”.

As illustrated in FIG. 7, first the pen is placed at the point indicated by the mark “1”, and is moved from “1” to “3” through “2”, and is detached at “3”. The width of the pen for the border is one pixel, and the width of the pen for the inner part is two pixels as indicated by the arrow. In addition, “black” is specified for the color of the border 21, and “grey” is specified for the color of the inner part 22. Further, as illustrated in FIG. 7, the coordinate of the pixel at the lower-left hand side corner is (0, 0) and the position of the pen is represented by the coordinate of the pixel indicated by the encircled mark “1” and the like.

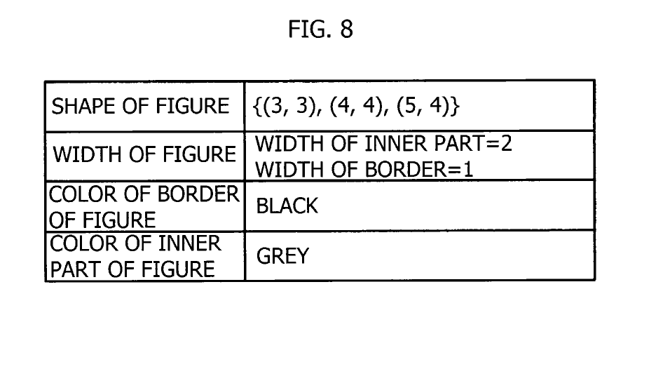

FIG. 8 is a diagram illustrating an example of figure information.

When a user draws a figure with a pen (mouse), figure information representing the figure is generated in the note PC 10 (see FIGS. 4 and 5). FIG. 8 is an example of the figure information, which is generated when the user draws the figure illustrated in FIGS. 6 and 7.

The figure information includes “the shape of the figure,” “the width of the figure,” “the color of the border of the figure,” “the color of the inner part of the figure.” “The shape of the figure” represents the movements of the center of a pen, which mean {(3, 3), (4, 4), (5, 4) } in the case of the figure depicted in FIGS. 5 and 6. “The width of the figure, ” “the color of the border of the figure” and “the color of the inner part of the figure” in the case of the figure depicted in FIGS. 6 and 7 are as described above.

Figure information as illustrated in FIG. 8 is generated for each figure, for which one stroke of pen (starting from the clicking of the start button of the mouse 131 and ending with the clicking of the stop button thereof) is recognized as one figure in the note PC 10. Further, the stroke order of the pen, which means the order of the generation of the figure information, is also stored in the note PC 10.

Following the generation of the figure information as illustrated in FIG. 8, drawing information which represents an image drawn on the display based on the figure information is generated.

An example of the generation processes of drawing information based on figure information is described below.

Here, drawing information is generated based on a figure corresponding to one stroke as illustrated in FIGS. 6 and 7 (figure information as illustrated in FIG. 8).

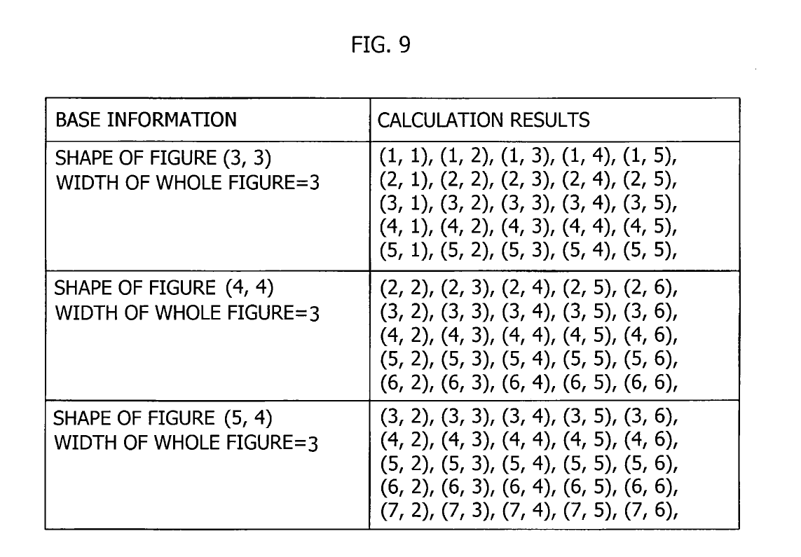

FIG. 9 is a diagram illustrating information in a phase of generating drawing information based on the figure information depicted in FIG. 8.

Since the pen moves from (3, 3) to (5, 4) through (4, 4), pixels used for drawing the figure are calculated at each point of the pen's movement, which is (3, 3), (4, 4) and (5, 4), respectively.

Since the width of the figure is “3” (the width of the border “1”+the width of the inner part “2”), 25 pixels from (1, 1) to (5, 5) are used for the drawing when the pen is located at (3, 3), for example. Similarly, when the pen is located at (4, 4) and (5, 4), 25 pixels are used for the drawing respectively.

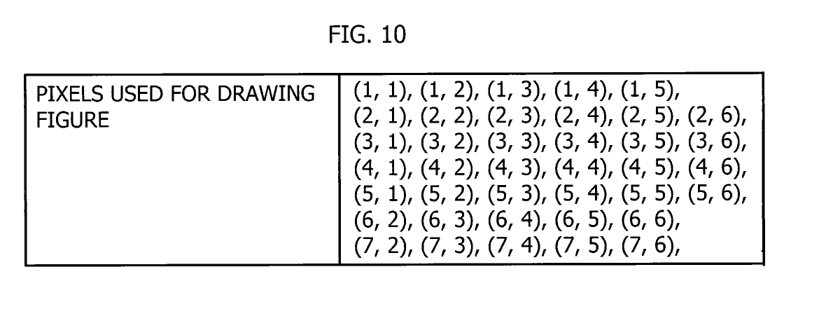

FIG. 10 is a diagram illustrating pixels used for drawing the figure depicted in FIGS. 6 and 7.

The information illustrated in FIG. 10 is generated by deleting redundant pixels from the information illustrated in FIG. 9.

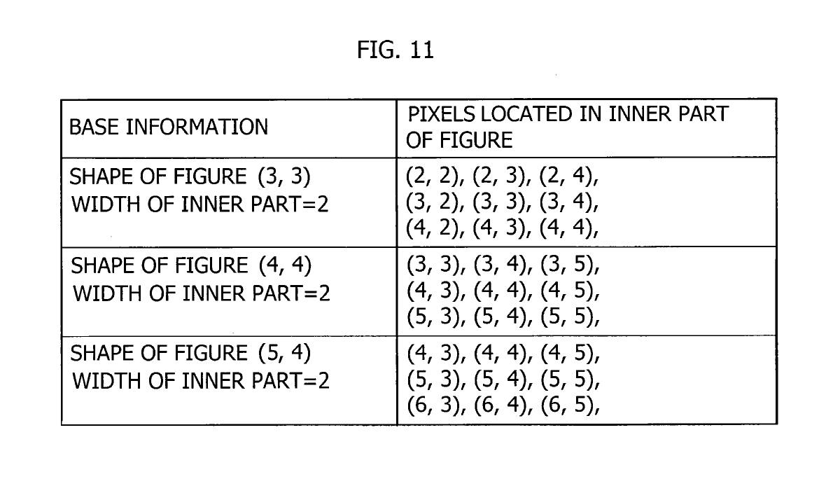

FIG. 11 is a diagram illustrating an example of the calculation of pixels used for drawing the inner parts of a figure at each point of the movement of the pen.

Since the width of the inner part of the figure is “2”, 9 pixels from (2, 2) to (2, 4), from (3, 2) to (3, 4) and from (4, 2) to (4, 4) are used for drawing the inner part when the pen is located at (3, 3) for example. Similarly, when the pen is located at (4, 4) and (5, 4), 9 pixels are used for drawing the inner part respectively.

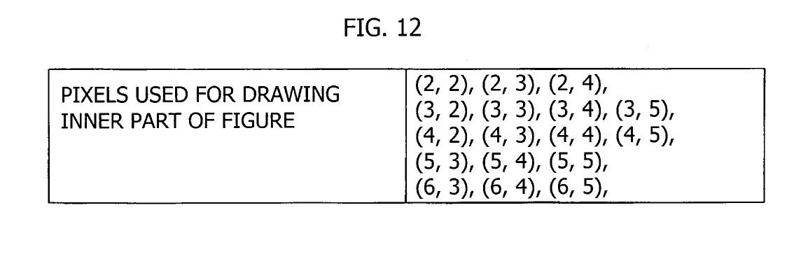

FIG.12 is a diagram illustrating pixels used for drawing the inner parts of the figure depicted in FIGS. 6 and 7.

The information illustrated in FIG. 12 is generated by deleting redundant pixels from the information illustrated in FIG. 11.

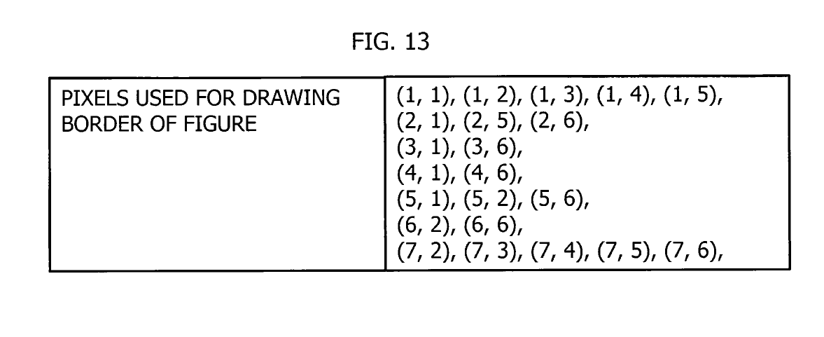

FIG. 13 is a diagram illustrating pixels used for drawing the borders of the figures depicted in FIGS. 6 and 7.

In FIG. 10, pixels are calculated for drawing the whole figure, and in FIG. 12 pixels are calculated for the inner part of the figure. Therefore, pixels illustrated in FIG. 13 are obtained for drawing the border of the figure by subtracting the pixels illustrated in FIG. 12 from the pixels illustrated in FIG. 10.

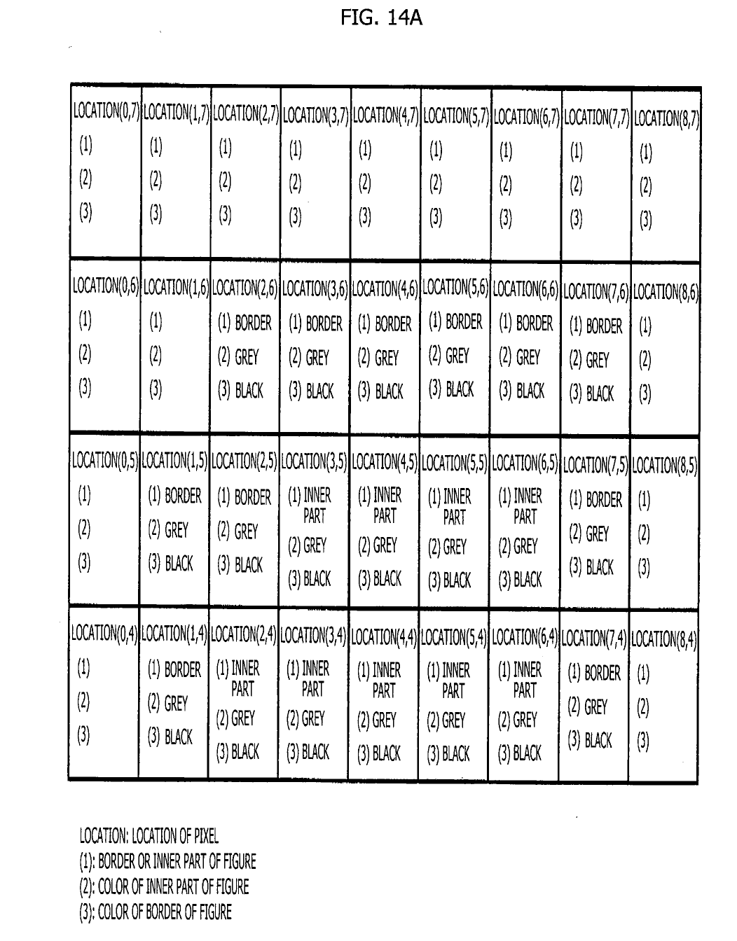

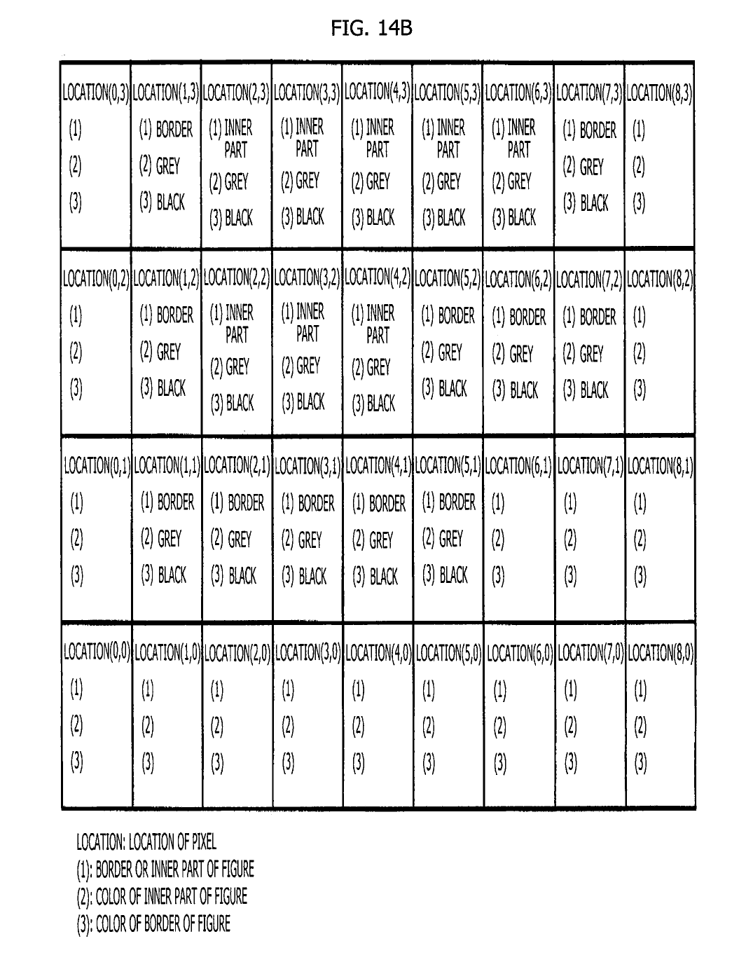

FIGS. 14A and 14B are diagrams illustrating the drawing information when the figures depicted in FIGS. 6 and 7 exist solely.

As described above, pixels of the border and the inner part of the figure are calculated respectively. The colors of the border and the inner part are specified in advance and registered in the drawing information illustrated in FIG. 7. Therefore, the above information is combined to obtain the drawing information which is the basis of the figure drawn on the display.

In FIGS. 14A and 14B, pixels for which the fields indicated by (1) to (3) are blank are pixels which are not subject to the drawing.

Next, processes for generating drawing information are described below when plural figures (a plurality of figure information) exist.

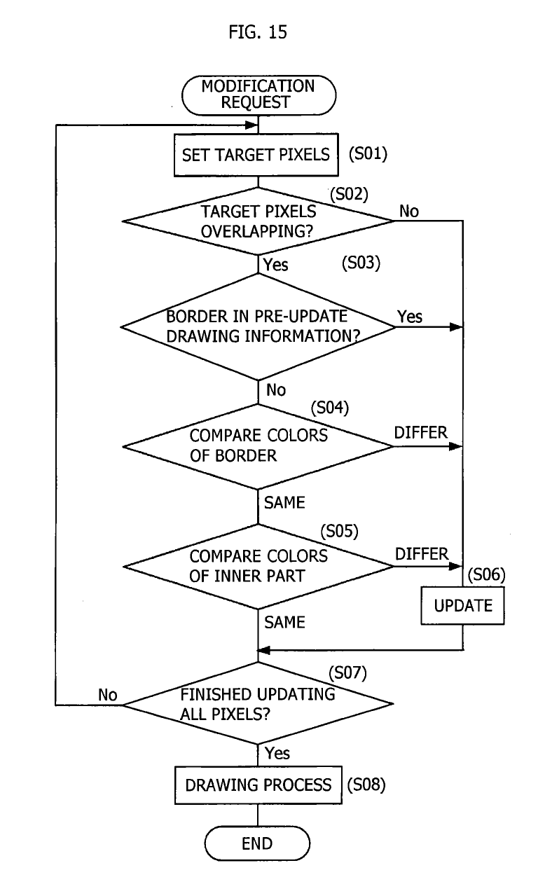

FIG. 15 is a flowchart illustrating processes for sequentially updating drawing information based on a plurality of figure information.

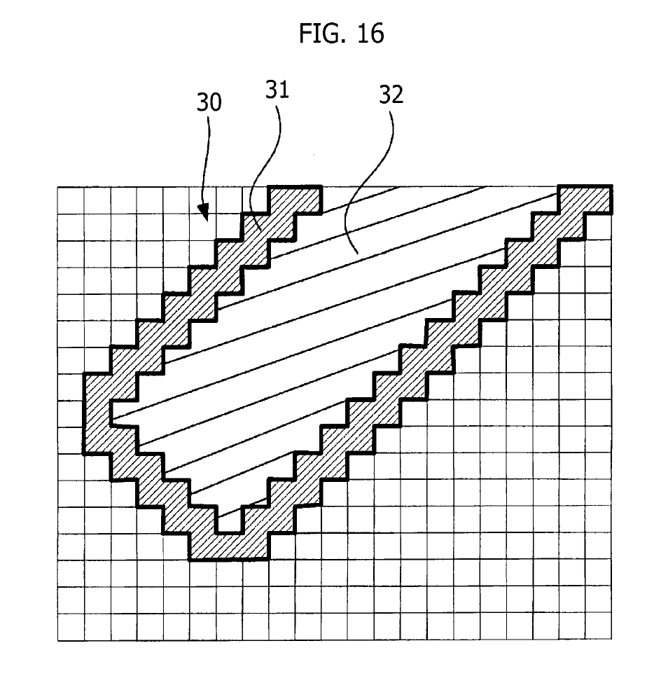

Hereinafter, brief explanations of the processes are given first with reference to the flowchart illustrated in FIG. 15, and then examples of the processes are explained with reference to FIG. 16 and the following figures.

For example, when a user uses a pen (mouse) to perform drawing operations to draw a new figure (with one stroke), new figure information is generated according to the new drawing operations in the note PC 10. When this new figure information is generated, an update request event occurs for the drawing information to execute the processes illustrated in FIG. 15. In the processes illustrated in FIG. 15, the drawing information which has been generated (hereinafter, referred to as “pre-update drawing information”) is updated based on the newly generated figure information.

When an update request for drawing information occurs, the following processes are executed for each pixel (for each grid corresponding to the border and the inner part of the figure depicted in FIGS. 6 and 7 for example) in the area which is covered by the figure drawn based on the drawing information (for example, see FIGS. 14A and 14B) generated solely from the newly generated figure information. Here, each pixel subject to the following processes is referred to as “target pixel.”

First, at step S01, a pixel in the area which is covered by the figure drawn based on the drawing information (for example, see FIGS. 14A and 14B) generated solely from the newly generated figure information is set as target pixel. The following processes are executed for the target pixel.

At step S02, it is determined whether or not the target pixel is redundant, that is, the target pixel is also used in the image based on the pre-update drawing information.

When the target pixel is not used in the image based on the pre-update drawing information, the color of the target pixel is updated with the color in the new figure information (step S06).

When the target pixel is redundant (step S02), that is, the target pixel is used in the image based on the pre-update drawing information, the process proceeds to step S03. In step S03, it is determined whether or not the target pixel corresponds to the border in the pre-update drawing information. When the target pixel corresponds to the border, the process proceeds to step S06 and the color of the pixel is updated with the color based on the new figure information.

When it is determined in step S03 that the target pixel corresponds to the inner part in the pre-update drawing information, then it is determined whether the color of the figure using the target pixel, which forms the image based on the pre-update drawing information, and the color of the figure drawn by the new drawing operations are the same or not. That is, it is determined that the colors of the borders of the two figures are the same (step S04) and the colors of the inner parts of the two figures are also the same (step S05), or that at least one of the colors of the borders and the inner parts are different. When either the colors of the borders or the inner parts are different, the process proceeds to step S06 and the color of the target pixel is updated with the color based on the new figure information which is generated by the new drawing operations. On the other hand, when the two figures are drawn with the same color, the update processes are not executed for the color of the target pixel. That is, the pre-update drawing information for the target pixel is still used with no change.

In step S07, it is determined whether or not the update processes are executed for all the pixels in the figure generated by the new drawing processes. When a remaining pixel exists, the process goes back to step S01, and the new pixel is set as target pixel and the same update processes are execute for the new target pixel.

When the update processes for all the pixels corresponding to the border and the inner part of the figure drawn by the new drawing operations (step S07) are completed, the new drawing information generated by the update processes this time are sent to the graphic unit 115 (see FIG. 5), and then the graphic unit 115 executes the drawing processes. Image data generated by the drawing processes are sent to the display 121 (see FIG. 5), which displays an image based on the image data.

The update processes illustrated in FIG. 15 are executed each time user's drawing operations of a figure corresponding to one stroke occur. Therefore, each time user's drawing operations of a figure corresponding to one stroke occur, the display 121 displays an image based on the drawing information which is updated with the figure corresponding to one stroke.

Next, one example of the update processes illustrated in FIG. 15 are explained specifically.

FIG. 16 is a diagram illustrating the pre-update drawing information as an image. Each rectangular grid represents a pixel.

The drawing information illustrated in FIG. 16 represents a FIG. 30 which includes the black border 31 and the grey inner part 32. As for the surrounding grids of the FIG. 30, one grid represents one pixel. The grids inside of the FIG. 30 are not depicted in order to avoid the complications of the figure.

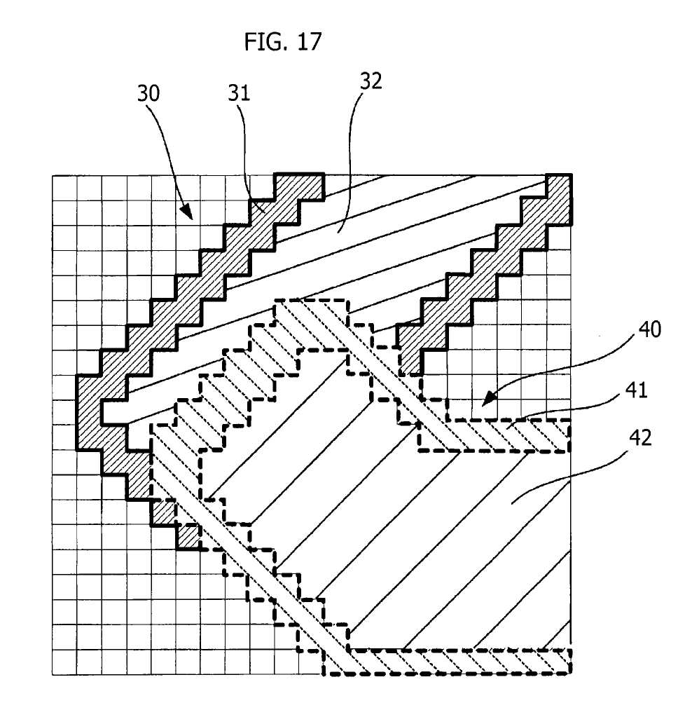

FIG. 17 is a diagram illustrating an image in which a new FIG. 40 is added to the FIG. 30 depicted in FIG. 16 by new drawing operations.

The new FIG. 40 includes the border 41 and the inner part 42, a part of which is drawn to overlap the original FIG. 30.

The border 31 is black and the inner part 32 is grey in the original FIG. 30. Here, in contrast, at least one of the colors of the border 41 and the inner part 42 of the new FIG. 40 differs from the counterpart of the original FIG. 30. In this case, for the part of the new FIG. 40 which does not overlap the original FIG. 30, the drawing information corresponding to the new FIG. 40 is added with no change (from step S02 to step S06 in FIG. 15). In addition, for the part of the new FIG. 40 which overlaps the original FIG. 30, the drawing information is updated in accordance with the new FIG. 40 (from step S04 or S05 to step S06 in FIG. 15). That is, when the new FIG. 40 is drawn with a color which differs from that of the original FIG. 30, drawing information is generated by superposing the new FIG. 40 on the original FIG. 30 with no change.

Next, explanations are given to a case in which the FIG. 40 is drawn with the same colors as the original figure (as a result, the border 41 is black and the inner part 42 is grey).

In this case, for the part of the new FIG. 40 which does not overlap the original FIG. 30, the drawing information corresponding to the new FIG. 40 is similarly added with no change (from step S02 to step S06 in FIG. 15).

As for the part of the new FIG. 40 which overlaps the original FIG. 30, the forms of overlapping are divided into four patterns.

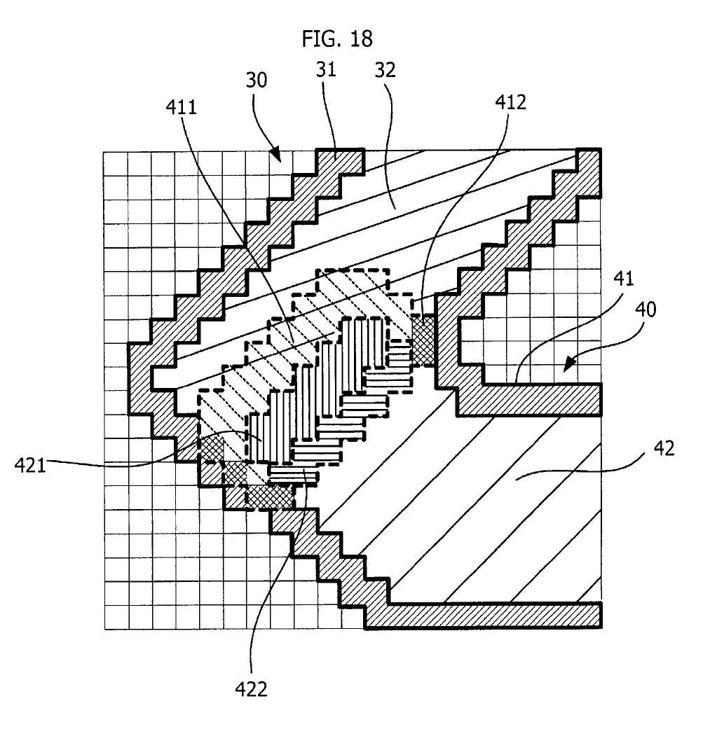

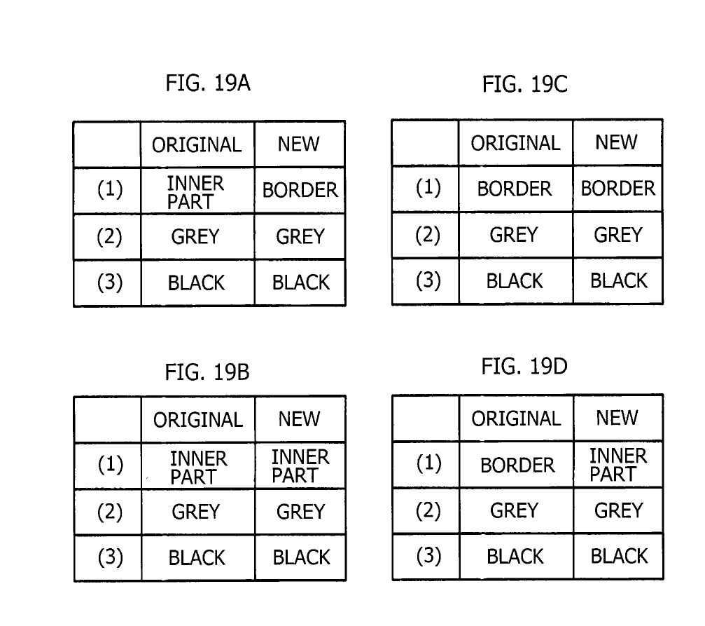

FIG. 18 is a diagram illustrating each part of four overlapping patterns. Additionally, FIG. 19 is a diagram illustrating the drawing information of the four overlapping patterns.

As illustrated in FIG. 19A, the area 411 in FIG. 18 is an area in which the border 41 of the new FIG. 40 overlaps the inner part 32 of the original FIG. 30. In this case, the process proceeds from step S03 to step S05 through step S04 in FIG. 15, and therefore the drawing information is not updated. That is, in this area 411, the drawing information of the original FIG. 30 is still effective with no change. Thus, in this area 411, the color (grey) of the inner part 31 of the original FIG. 30 is still effective with no change.

As illustrated in FIG. 19B, the area 421 in FIG. 18 is an area in which the inner part 41 of the new FIG. 40 overlaps the inner part 32 of the original FIG. 30. Similar to the area 411, the drawing information is not updated for each pixel in the area 421, and the color (grey) of the inner part 32 of the original FIG. 30 is still used with no change (from step S03 to step S05 through step S04 in FIG. 15).

As illustrated in FIG. 19C, the area 412 in FIG. 18 is an area in which the border 41 of the new FIG. 40 overlaps the border 31 of the original FIG. 30. In this case, the process proceeds from step S03 to step S06 in FIG. 15, and the drawing information of the area 421 is updated with the color (black) of the border 41 of the new FIG. 40.

Further, as illustrated in FIG. 19D, the area 422 in FIG. 18 is an area in which the inner part 41 of the new FIG. 40 overlaps the border 31 of the original FIG. 30. Similar to the area 412 in FIG. 18, in this case, the process proceeds from step S03 to step S06 in FIG. 15. That is, here, the drawing information is updated with the color (grey) of the inner part 42 of the new FIG. 40.

FIG. 20 is a diagram illustrating as an image the drawing information which is newly generated by the above-described update processes.

As a result of the update processes of drawing information as described above, unnecessary borders between the original FIG. 30 and the new FIG. 40 are deleted and one united figure is depicted.

When further new drawing operations occur for drawing the following figure after the drawing information corresponding to the image illustrated in FIG. 20 is generated, the update processes are repeated by handling the drawing information representing the image illustrated in FIG. 20 as the original figure.

Next, explanations are given to processes when a modification request for a generated figure is submitted. Here, “modification” means some sort of modification of a figure such as a change of the figure's location, a rotation of the figure, and a scale-up or scale-down of the figure and the like.

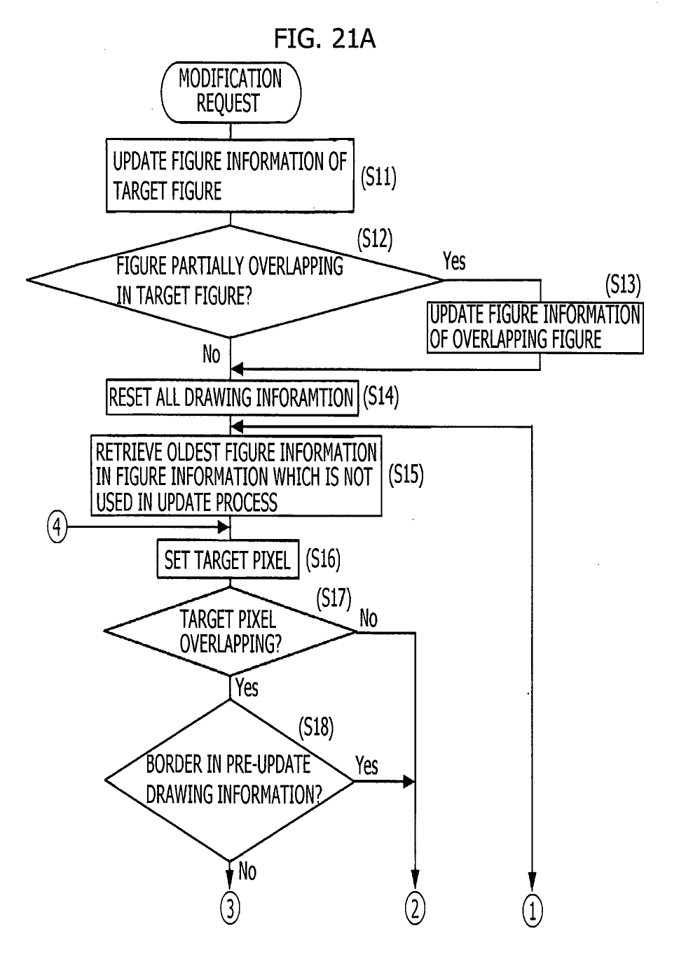

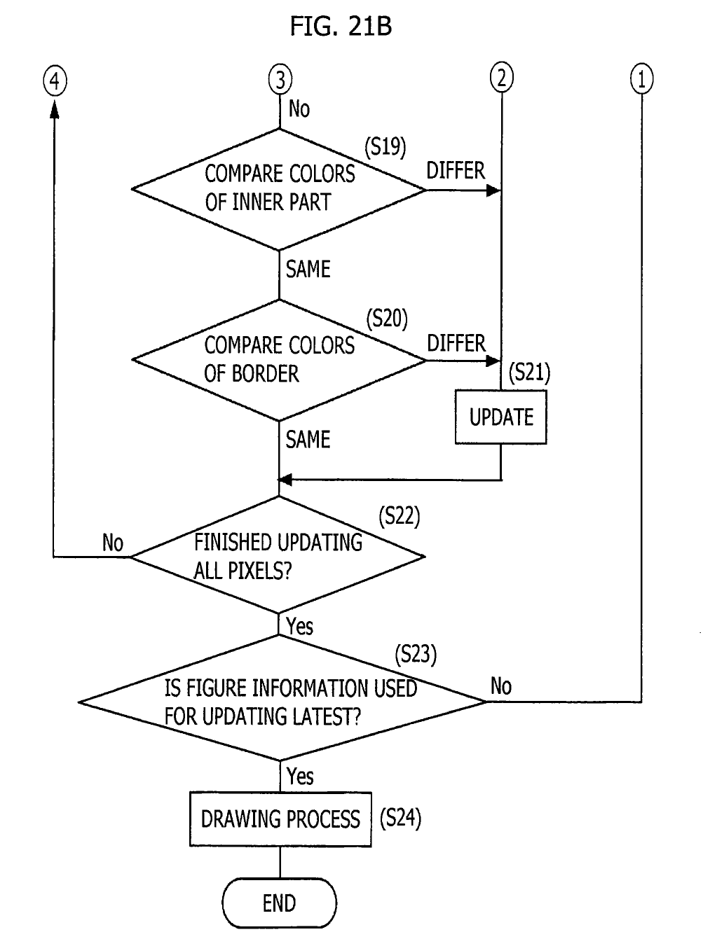

FIGS. 21A and 21B are flowcharts of drawing information regeneration processes which are executed when a modification request is submitted.

First, the figure information of the figure which is subject to the modification is updated according to the modification request (step S11). Next, it is determined whether among figures with colors (of the border and the inner part) which are the same as the colors of the figure subject to the modification (the figure before the modification), a figure which partially overlaps the figure subject to the modification exists or not (step S12). When a figure with the same colors and with the partially overlapping part exists, the figure information of the overlapping figure is also updated (step S13).

Next, the entire drawing information is reset and restored to the state in which nothing is drawn (step S14).

Then, among the figure information which is not used in the update processes of the drawing information, the oldest figure information is retrieved (step S15). In the following steps S16 through S22, the drawing information is updated based on the retrieved figure information. Since each process in steps S16 through S22 is the same as each process in steps S01 through S07 illustrated in FIG. 15, redundant explanations are omitted here.

However, here, even when the figure information is updated in steps S11 and S13, the time-series order of the figure information is the same as that of the figure information before the update processes. The oldest figure information is retrieved in step S15 immediately after the entire drawing information is reset in step S14, and then drawing information is generated firstly based on the oldest figure information in the following steps.

In step S23, it is determined whether or not the figure information which is used this time in the update processes of the drawing information is the latest among the figure information. When the figure information which is used this time in the update processes of the drawing information is not the latest, the process goes back to step S15 and the update processes of drawing information are executed based on the figure information which is the latest next to the figure information used this time. When it is determined in step S23 that the figure information used this time is the latest, the process proceeds to step S24. In step S24, the drawing information updated as the latest is sent to the graphic unit 115 (see FIG. 5), and then the graphic unit 115 executes drawing processes. Image data generated by the drawing processes is sent to the display 121 (see FIG. 5), and then the display 121 displays an image based on the image data, namely, an image obtained after the modification processes of the figure are executed.

Next, a specific example of the processes illustrated in FIGS. 21A and 21B is described below.

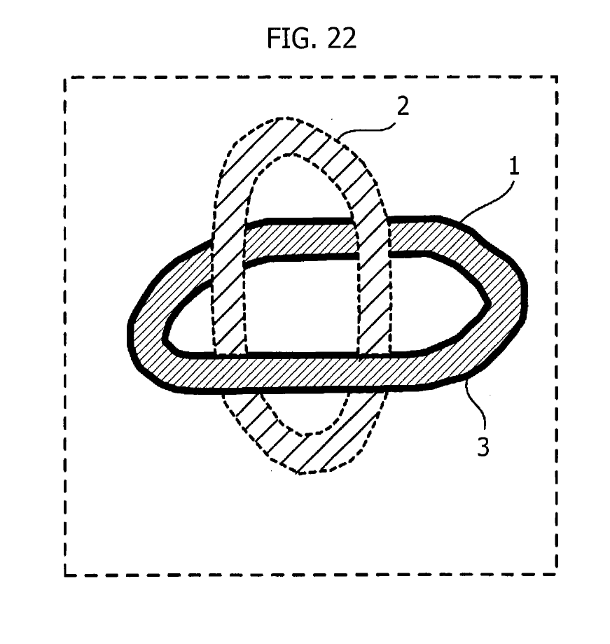

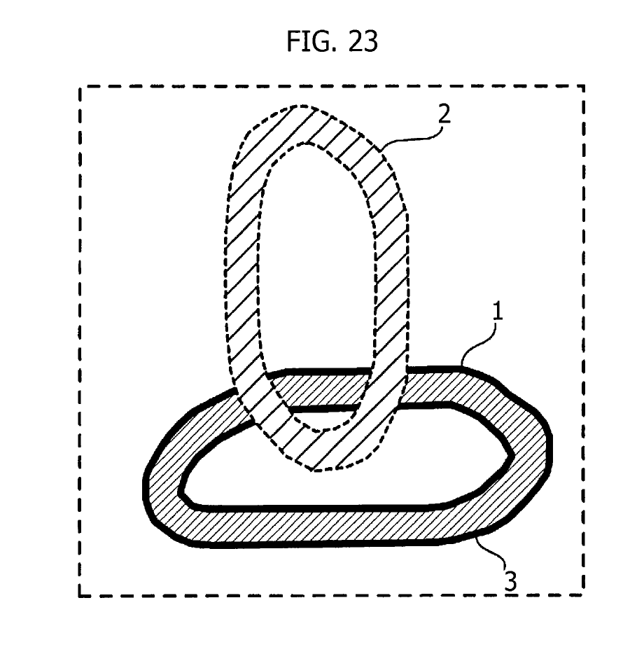

FIGS. 22 and 23 illustrate images displayed on the display before and after the modification processes respectively.

Here, explanations are given in regard to the figure described above with reference to FIG. 2. That is, the image illustrated in FIG. 22 is formed by FIGS. 1, 2 and 3 corresponding to three strokes. Since FIGS. 1 and 3 have the same colors, the borders which form the boundaries of the figures are deleted according to the flowchart illustrated in FIG. 15.

Here, the figure illustrated in FIG. 22 is modified to obtain the figure illustrated in FIG. 23.

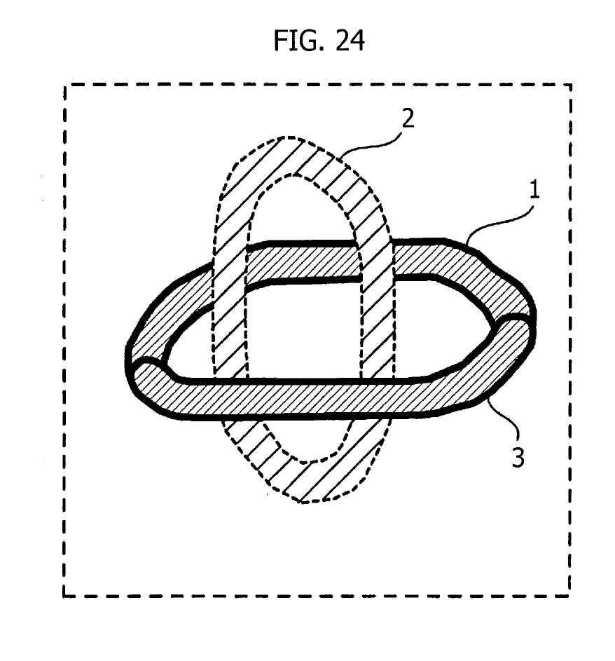

FIG. 24 illustrates an image in which the borders of the boundaries between FIG. 1 and FIG. 3 are deleted for the sake of convenience. However, the borders of the boundaries are not displayed on the display.

Here, it is assumed that the user manipulates the mouse to move FIG. 1 in a downward direction. At this point, the figure information of FIG. 1 is updated in step Sll illustrated in FIG. 21A.

In addition, it is determined in step S12 that FIG. 1 and FIG. 3 have the same colors and FIGS. 1 and 3 partially overlap each other, and then the figure information of FIG. 3 is also updated in step S13.

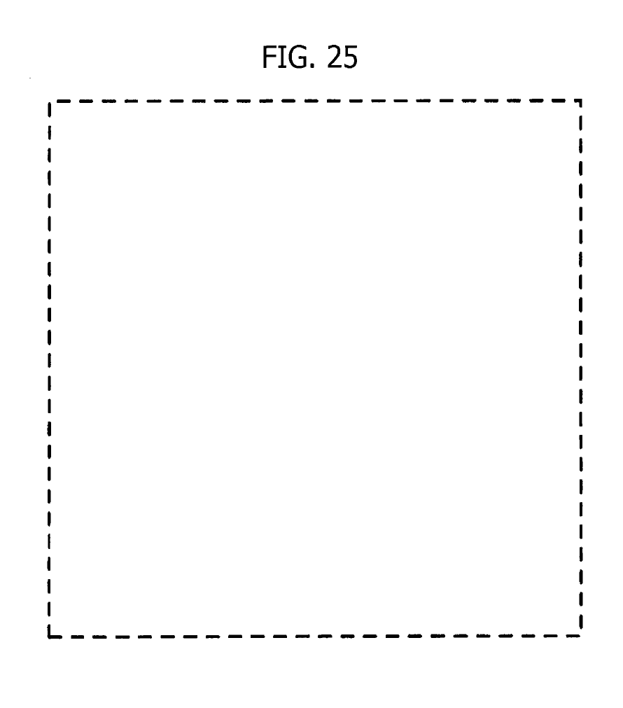

FIGS. 25 through 28 are diagrams illustrating figures representing each stage of the update processes of the drawing information.

In step S14 illustrated in FIG. 21A, the entire drawing information is reset. Therefore, when drawing processes are executed at this stage, nothing is displayed on the display as illustrated in FIG. 25.

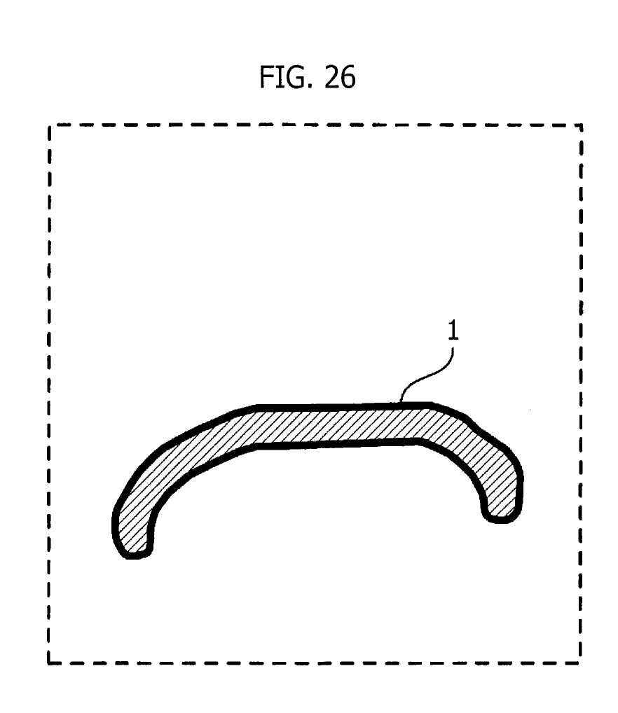

Next, drawing information is generated based on the figure information of FIG. 1, which is the oldest figure information (steps S15 through S23 illustrated in FIGS. 21A and 21B). The drawing information generated at this stage is the drawing information representing an image illustrated in FIG. 26. However, nothing is still displayed on the display at this stage.

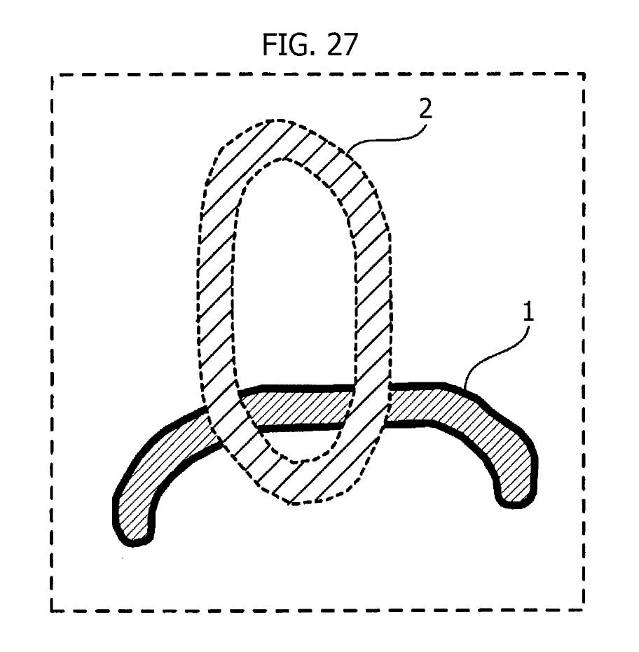

Next, the drawing information is updated based on the figure information of FIG. 2. The drawing information updated at this point is the drawing information representing the image illustrated in FIG. 27. However, no image is still displayed on the display at this stage.

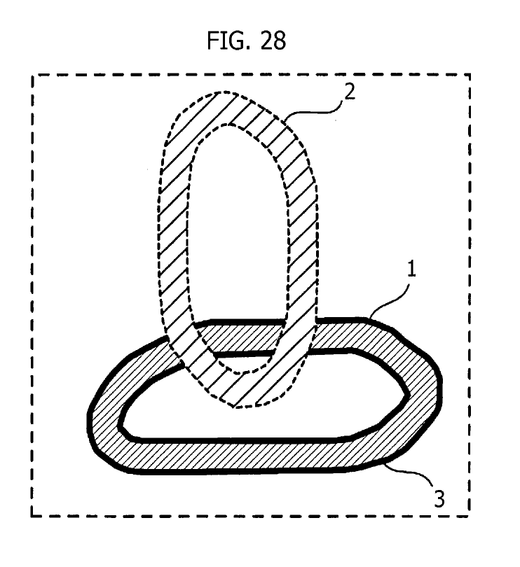

Further, the drawing information is updated based on the figure information of FIG. 3. The drawing information updated at this point is the drawing information representing the image illustrated in FIG. 28. The figure information of FIG. 3 is the latest in this example. Therefore, the process proceeds to step S24 in FIG. 21B, and then drawing processes are executed based on this drawing information to display the image illustrated in FIG. 27, which is the same as the image illustrated in FIG. 23, on the display.

Unnecessary borders are similarly deleted in this image obtained after the modification processes.

According to a drawing apparatus and a drawing program described herein, a figure is drawn where unnecessary borders in the overlapping parts are deleted and the inner parts are united.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A drawing apparatus, comprising:
a figure information generating unit sequentially generating figure information representing each figure, in which one stroke of line with border is recognized as one figure, based on a drawing operation using a line with border to which color information of a border and an inner part is given;
a drawing information generating unit generating drawing information on which drawing is based using the figure information; and
a drawing processing unit executing a drawing process based on the drawing information generated by the drawing information generating unit,
wherein when a figure forming a pre-update image represented by pre-update drawing information and a new figure represented by new drawing information overlap each other and when colors of borders of the overlapping figures are the same and colors of inner parts of the overlapping figures are the same, then the drawing information generating unit updates the pre-update drawing information with new drawing information which represents a figure in which the inner parts of the overlapping parts are united.

2. The drawing apparatus according to claim 1, wherein:
the drawing information generating unit
divides the new figure represented by the new figure information into a non-overlapping area, which does not overlap the pre-update image represented by the pre-update drawing information, and an overlapping area, which overlaps the pre-update image, and then adds the drawing information based on the new figure information to the pre-update drawing information as for the non-overlapping area,
divides the overlapping area into a border-overlapping area, which overlaps the border of the figure forming the pre-update image, and an inner-part-overlapping area, which overlaps the inner part of the figure forming the pre-update image, and then updates the pre-update drawing information with the new drawing information based on the figure information representing the new figure as for the border-overlapping area,
updates the pre-update drawing information with the new drawing information based on the figure information representing the new figure as for the inner-part-overlapping area when the new figure and the figure forming the pre-update image and overlapping the new figure are compared to show that at least one of the colors of the borders and the inner parts of the figures is different, and
thereby generates latest drawing information by executing a process for updating the pre-update drawing information with post-update drawing information in sequential order from figure information generated by a preceding drawing operation to figure information generated by a following drawing operation.

3. The drawing apparatus according to claim 1, wherein:
the drawing information generating unit receives a modification request of a figure drawn by a drawing operation, and when a figure forming a pre-update image represented by pre-update drawing information and a figure subject to the modification request overlap each other and when colors of borders of the overlapping figures are the same and colors of inner parts of the overlapping figures are the same, then modifies figure information of the figure subject to the modification request according to the modification request, and, as for the figure overlapping the figure subject to the modification request, modifies figure information of the overlapping figure according to the modification request, and
the drawing information generating unit newly generates drawing information when the figure information generating unit modifies the figure information.

4. The drawing apparatus according to claim 1, further comprising:
an input operator accepting a drawing operation by a user.

5. The drawing apparatus according to claim 1, further comprising:
a display displaying an image based on image data generated by a drawing process in the drawing processing unit.

6. A non-transitory computer-readable storage medium having stored therein a program for causing a computer to execute a moving image output process comprising:
sequentially generating figure information representing each figure, in which one stroke of line with border is recognized as one figure, based on a drawing operation using a line with border to which color information of a border and an inner part is given;
generating drawing information on which drawing is based using the figure information; and
executing a drawing process based on the drawing information generated by the generating drawing information,
wherein, in the generating drawing information, when a figure forming a pre-update image represented by pre-update drawing information and a new figure represented by new drawing information overlap each other and when colors of borders of the overlapping figures are the same and colors of inner parts of the overlapping figures are the same, then the pre-update drawing information is updated with new drawing information which represents a figure in which the inner parts of the overlapping parts are united.

7. The non-transitory computer-readable storage medium according to claim 6, wherein:
in the generating drawing information,
the new figure represented by the new figure information is divided into a non-overlapping area, which does not overlap the pre-update image represented by the pre-update drawing information, and an overlapping area, which overlaps the pre-update image, and then the drawing information based on the new figure information is added to the pre-update drawing information as for the non-overlapping area,
the overlapping area is divided into a border-overlapping area, which overlaps the border of the figure forming the pre-update image, and an inner-part-overlapping area, which overlaps the inner part of the figure forming the pre-update image, and then the pre-update drawing information is updated with the new drawing information based on the figure information representing the new figure as for the border-overlapping area,
the pre-update drawing information is updated with the new drawing information based on the figure information representing the new figure as for the inner-part-overlapping area when the new figure and the figure forming the pre-update image and overlapping the new figure are compared to show that at least one of the colors of the borders and the inner parts of the figures is different, and
thereby latest drawing information is generated by executing the process for updating the pre-update drawing information with post-update drawing information in sequential order from figure information generated by a preceding drawing operation to figure information generated by a following drawing operation.

8. The non-transitory computer-readable storage medium according to claim 6, wherein:
in the generating figure information,
a modification request of a figure drawn by a drawing operation occurs, and when a figure forming a pre-update image represented by pre-update drawing information and a figure subject to the modification request overlap each other and when colors of borders of the overlapping figures are the same and colors of inner parts of the overlapping figures are the same, then figure information of the figure subject to the modification request is modified according to the modification request, and, as for the figure overlapping the figure subject to the modification request, figure information of the overlapping figure is modified according to the modification request, and
drawing information is newly generated when the figure information generating unit modifies figure information.
